(19) United States
(12) Patent Application Publication
(10) Pub. No.: US 2005/0242521 A1
(43) Pub. Date: Nov. 3, 2005

(54) Radial shaft sealing ring

(76) Inventors: Eberhard Bock, Morlenbach (DE); Rolf Vogt, Oftersheim (DE); Holger Sattler, Wald-Michelbach (DE)

Correspondence Address: HARNESS, DICKEY & PIERCE, P.L.C., P.O. BOX 828, BLOOMFIELD HILLS, MI, 48303, US

(21) Appl. No.: 11/116,095

(22) Filed: Apr. 27, 2005

(30) Foreign Application Priority Data
Apr. 28, 2004 (DE) 102004020966.9

(51) Int. Cl. F16J 15/32

(52) U.S. Cl. 277/559

(57) ABSTRACT

A radial shaft sealing ring with a backing ring and a sealing element made of an elastomeric material vulcanized onto it. The sealing element has a lip seal which, for the uninstalled sealing ring, protrudes from the backing ring in radial direction. When the ring is installed in the opening of a housing in a prestressed condition, the lip seal surrounds the shaft with its curved sealing surface. The lip seal consists of an elastomer and its sealing surface consists of a sealing bulge disposed at the end of the lip seal. The lip seal surrounds the shaft and a surface segment attached thereto retains or returns leaking liquid. The terminal surface of the lip seal, when the sealing element is installed, is oriented toward the internal space of a housing that is to be sealed.

### CROSS-REFERENCE TO RELATED APPLICATIONS

This application claims the benefit of German Patent Application 10 2004 020 966.9, filed Apr. 28, 2004. The disclosure of the above application is incorporated herein by reference.

### FIELD OF THE INVENTION

The invention relates to a radial shaft sealing ring with a backing ring and a sealing element made of an elastomer attached thereto by vulcanization. The sealing element is made of an elastomeric material and has a lip seal which, when the sealing ring in not yet installed, protrudes from the backing ring in radial direction. When the sealing ring is fitted into the opening of a housing, the lip seal is pre-stressed and, with its curved sealing surface, surrounds the shaft.

### BACKGROUND OF THE INVENTION

Sealing rings are widely known and are used to seal an internal space filled with liquid from the surroundings. Such a seal should provide good sealing both statically during shaft stoppage and dynamically when the shaft is rotating. Leaks should be virtually prevented. Moreover, the seals should also provide tight sealing for different directions of rotation.

The possibility of sealing a shaft that can rotate in both directions is indicated in U.S. Pat. No. 4,834,397. Among other things, this patent shows, in FIG. 4, an embodiment in which a relatively hard fluoropolymer, for example polytetrafluoroethylene, is used for the lip seal, wherein the lip seal is held in appropriate holders. The sealing surface in contact with the shaft is divided by a groove so that two bulge-like sealing surfaces are formed. In this case, the force with which the first sealing surface that faces the inner space is pressed against the shaft is lower than that exerted against the outer sealing surface. Moreover, the all-around extending groove is configured so that with the first sealing surface it forms a sharp edge, and with the second sealing surface it forms a curved edge. The fabrication of such a seal is very expensive and requires very high precision both in terms of the material used and as regards its spatial arrangement.

A seal comparable to the afore-described embodiment is shown in EP 0 798 498 A1. In this case, too, the sealing surface is interrupted by an all-around extending groove, so that two partial surfaces are present. Unlike in the afore-described embodiment, here the groove is sloped in the opposite direction and, moreover, the terminal surface of the lip seal is provided with an adapting part. The groove bottom is fitted with an undulation which, when the rotational movement starts, causes the first sealing surface to lift from the shaft surface as a result of which the leaking liquid is returned. In the examples given in this case, too, a lip seal made of PTFE is used. Such a seal can be used for shafts that are to be sealed when rotating in either direction.

Another method of shaft sealing is described in DE 100 33 446 C2. In this case, a shaft sealing ring made of an elastomeric material is used. On the side facing the shaft, the lip seal is provided with a thread which, while the shaft is rotating, returns the escaping medium to the space to be sealed. To achieve static sealing, also when the shaft is standing still, the thread is isolated from the surroundings by means of a stem. The thread is present on both sides of the stem. Such an embodiment permits rotation in the opposite direction for only a short time, because extended back-rotation of the shaft results in considerable positive and negative pressures at the stem, which enables large amounts of leaking fluid to escape. Moreover, such embodiments do not lend themselves to sealing against pressure

### SUMMARY OF THE INVENTION

The object of the invention is to provide an improved radial shaft sealing ring that provides good sealing over a prolonged period of time, and that will withstand a reversal in the direction of shaft rotation for at least a limited length of time. Moreover, the ring should provide adequate sealing also against elevated pressures.

In the radial shaft sealing ring according to the invention, a lip seal is provided having a sealing surface that consists of a sealing bulge disposed at the end of the lip seal that extends all around the shaft, and an adjacent surface segment that holds back or returns the leaking liquid. The terminal surface of the lip seal, for the installed sealing element, is directed toward the internal space of the housing to be sealed. The sealing bulge provides good static sealing when the shaft is standing still. The surface segment directly adjacent to the sealing bulge holds back or returns the leaking liquid. In this respect, it is of importance that the terminal surface of the lip seal, for the installed sealing element, is oriented toward the internal space of the housing to be sealed.

For the leaking liquid to be retained or returned by the surface segment, the segment is provided with hydro-dynamically acting return grooves for the leaking liquid. To this end, it is advantageous for the return grooves to be formed by a single-flight thread. The thread extends in the sealing bulge over a fairly long distance and becomes gradually flatter. The distance should amount to at least ¼ of the sealing bulge circumference.

The thread can be of a triangular sharp-V kind. Good results were also obtained with saw-toothed threads with inward-oriented tips. The leading front of the teeth are then approximately perpendicular to the middle plane of the lip seal.

The thread of the surface segment extending in the sealing bulge imparts to the sealing bulge a different contact width with which it touches the shaft. It is important to note that at its narrowest point this contact width amounts to 0.1 to 0.8 mm. Smaller contact widths can cause insufficient sealing, whereas excessively large contact widths can hinder lubrication.

The depth of the thread relative to the thickness of the lip seal is in preferably the range from 0.46 to 0.67 of the lip seal thickness. The ratio of lip seal thickness to thread depth is then preferably from 1.5 to 2.2. Note in this respect that the contact width of the sealing bulge is inversely proportional to the thread depth so that a smaller contact width means a larger thread depth, and a larger contact width a smaller thread depth.

To make sure that dirt particles or the like stemming from the internal space will not end up below the sealing bulge, the terminal surface of the lip seal is oriented toward the surface of the shaft so that it forms an angle α that is preferably between 800 to 1000. On the outside, for an installed sealing element, an angle β that is preferably from 0° to 200 is formed at the lip seal.

Also exerting an influence on the sealing performance is the extent to which the sealing surface covers the shaft. It was established by tests that best results are obtained when the overlap (φD-φB) amounts to about 3 to 10% of the shaft diameter. For many applications for which the shaft diameter is 45 mm, an overlap of 2 to 5 mm is preferably chosen.

A displacement C of the center line of the lip seal 4 from the center line of the shaft 6 is advantageous. The displacement results in locally different pressures of lip seal 4 against shaft 6 and in an edge 7 which extends sinusoidally and is displaced over the circumference of shaft 6. This leads to a better lubricant exchange.

The sealing ring is provided with a conventional backing ring. Preferably, however, the backing ring consists of a curved metallic ring. The outer, axially extending part of the ring is at least partially surrounded by the elastomeric material of the sealing element and is inserted into the housing as a pinching or static sealing ring. The inner, radially extending ring part is enclosed on its internally disposed edge by the material constituting the sealing element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in greater detail by reference to the exemplary embodiments represented by the drawings in which:

FIG. 1 is an enlarged representation of the principle of the embodiment of the lip seal on a shaft;

FIG. 2 is a sectional view of the radial shaft sealing ring before it is installed according to a principle of the present invention;

FIG. 3 shows an enlarged lip seal according to a principle of the present invention; and

FIG. 4 is an interior view of a lip seal segment with the thread extending in the sealing bulge according to a principle of the present invention.

### DETAILED DESCRIPTION OF THE PREFERRED EMBODIMENTS

The following description of the preferred embodiments is merely exemplary in nature and is in no way intended to limit the invention, its application, or uses.

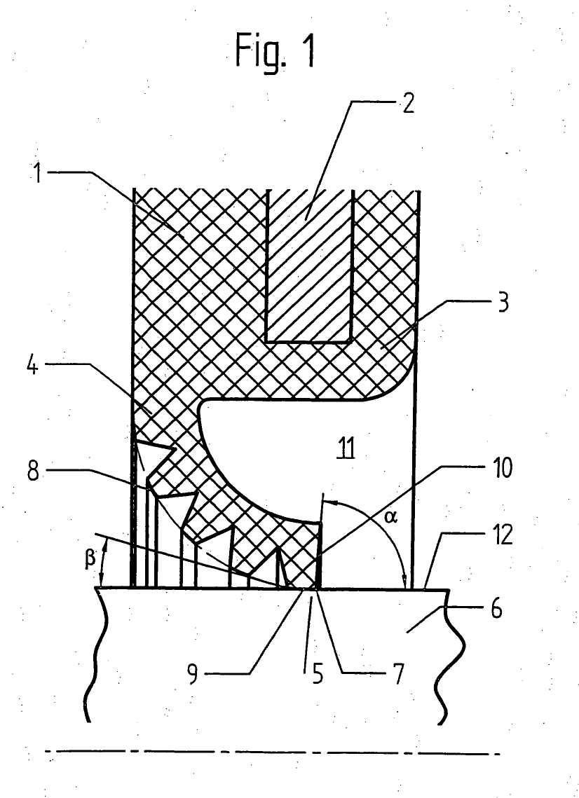

FIG. 1 shows schematically the cross-section of a part of the radial shaft sealing ring 1. A sealing element 3 is vulcanized onto a backing ring 2. Sealing element 3 consists of a soft elastomeric material and is provided with a lip seal 4 which, when installed under its own elastic tension, surrounds a shaft 6 with its sealing surface 5. Sealing surface 5 is formed by a bulge 7 and a short surface segment 9 that is oriented toward an outer surface 8, namely toward the outward-directed side of lip seal 4. A terminal surface 10 of lip seal 4 is oriented toward an internal space 11 of a housing (not shown). Terminal surface 10 of lip seal 4 forms with surface 12 of shaft 6 an angle α of about 87°. This angle α is greater than an angle β formed between the outward-oriented surface 8 of lip seal 4 and shaft surface 12. In this exemplary embodiment, angle β amounts to about 15°. Such a seal can also withstand higher internal pressures, because with increasing pressure, bulge 7 is pressed more tightly against shaft 6.

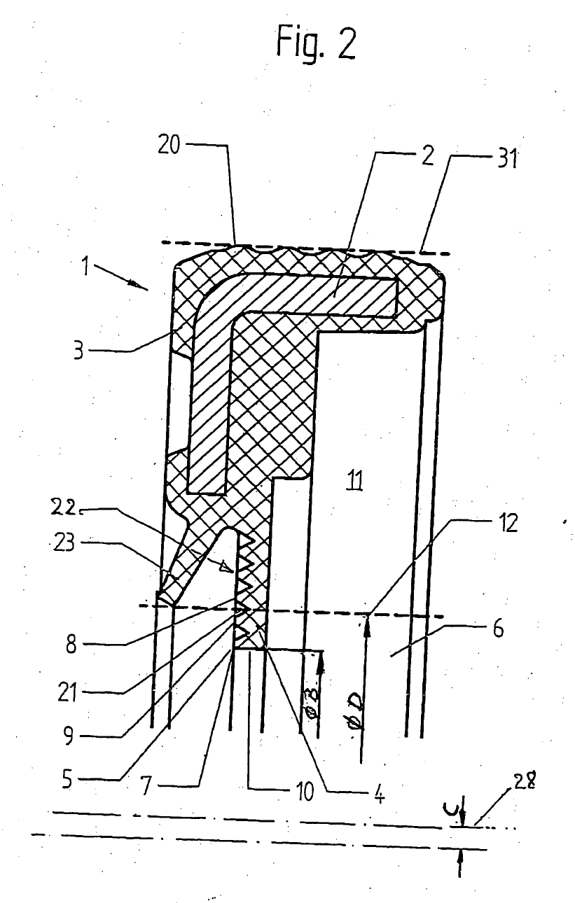

FIG. 2 shows a radial shaft sealing ring 1 in cross-section before the ring 1 is installed. Onto a backing ring 2 is vulcanized a sealing element 3 which, with its outer periphery 20, serves both as a seal toward a housing 31, and as a seal toward shaft 6, indicated only by a broken line. For sealing at shaft 6, sealing element 3 is provided with a lip seal 4. Lip seal 4 has a sealing bulge 7 that extends all around shaft 6. The lip seal 4 is attached to a surface segment 9 which, in this exemplary embodiment, is formed by return grooves 21 of a single-flight thread. The thread has inward-oriented tips 22. Sealing element 3 is also provided with dust lip 23. A diameter D of shaft 6 and the inner diameter B of lip seal 4 are so adapted to each other that, for the installed sealing ring 1, a sealing surface 5, consisting of the sealing bulge 7 and the surface segment 9, is formed with the surface segment 9 having at least one thread flight. The drawing also shows a desirable displacement C of the middle line 28 of lip seal 4 from the middle line 29 of shaft 6. This displacement results in locally different pressures of lip seal 4 against shaft 6 and in a sinusoidally extending edge 7 displaced over the circumference of shaft 6 and provides a definitely better lubricant exchange.

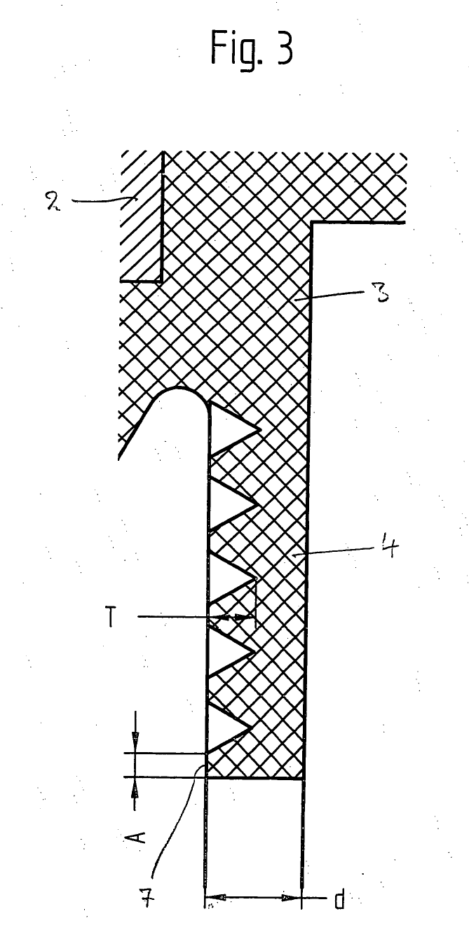

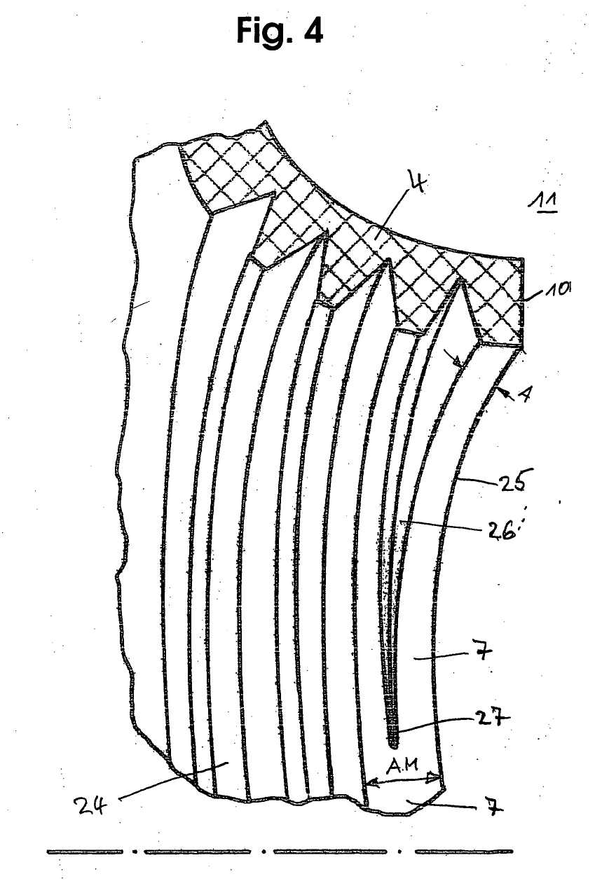

FIG. 3 depicts a lip seal 4 which is enlarged to show the lip seal thickness d, a thread depth T, and contact width A of the sealing bulge 7. Contact width A is measured at the narrowest point 25 of sealing bulge 7 which lies at the end of thread 24 in sealing bulge 7 (FIG. 4). The minimum contact width A is a function of shaft diameter D and of the operating conditions, and amounts to preferably about 0.1-0.8 mm. Depth T of thread 24 is selected in relation to lip seal thickness d and amounts to preferably about 0.46 to 0.67 of the lip seal thickness d. Contact width A of sealing bulge 7 is, in this case, inversely proportional to thread depth T, meaning that a smaller contact width A is associated with a larger thread depth and, inversely, that a larger contact width A is associated with a smaller thread depth T.

FIG. 4 shows an enlarged interior view of the configuration of a thread outlet 26 in bulge 7. Thread outlet 26 preferably extends over about 0.25 to 0.5 of the circumference of sealing bulge 7 so that an adequately long path is available for outlet 26. In this manner, the return of the leaking liquid is facilitated when the shaft 6 is rotating. A minimum width A of sealing bulge 7 must be maintained. As a result of the outlet 26 of thread 24 in bulge 7, a wider contact width AM of thread 24 is provided at the outlet end 27.

The description of the invention is merely exemplary in nature and, thus, variations that do not depart from the gist of the invention are intended to be within the scope of the invention. Such variations are not to be regarded as a departure from the spirit and scope of the invention.

1. A radial shaft sealing ring with a backing ring and a sealing element made of an elastomeric material vulcanized onto the backing ring, said sealing element comprising:
a lip seal which for the uninstalled sealing ring protrudes from the backing ring in a radial direction and when installed in a housing opening in a prestressed condition surrounds a shaft with a curved sealing surface;
said lip seal being comprised of an elastomer and having a sealing surface that consists of a sealing bulge disposed at an end of said lip seal, said sealing bulge surrounding the shaft and retaining or returning a leaking liquid with a surface segment;
wherein a terminal surface of said lip seal, when the sealing element is installed, is oriented toward an internal space of a housing that is to be sealed.

2. The radial shaft sealing ring according to claim 1, wherein said surface segment is provided with a hydro-dynamically acting return grooves for said leaking liquid.

3. The radial shaft sealing ring according to claim 2, wherein said return grooves are formed of a single-flight thread.

4. The radial shaft sealing ring according to claim 3, wherein said thread extends in said sealing bulge over a fairly long distance and gradually becomes flatter.

5. The radial shaft sealing ring according to claim 4, wherein an outflow distance of said thread amounts to about ¼ to ½ of a circumference of said sealing bulge.

6. The radial shaft sealing ring according to claim 3, wherein said thread is provided with inward-oriented tips.

7. The radial shaft sealing ring according to claim 1, wherein for the installed sealing element, said terminal surface of said lip seal forms with a surface of the shaft an angle α between 80° and 100°.

8. The radial shaft sealing ring according to claim 1, wherein for the installed sealing element, said sealing surface of said lip seal forms with a surface of the shaft an angle β of between 0 and 20°.

9. The radial shaft sealing ring according to claim 1, wherein a contact width of said sealing bulge at a narrowest point of the sealing bulge amounts to 0.1-0.8 mm.

10. The radial shaft sealing ring according to claim 9, wherein said contact width of said sealing bulge at its narrowest point on the shaft amounts to 0.1 mm.

11. The radial shaft sealing ring according to claim 9, wherein said contact width of said sealing bulge at its narrowest point on the shaft amounts to up to 0.8 mm.

12. The radial shaft sealing ring according to claim 3, wherein a depth of said thread amounts to 0.46 to 0.67 of a lip seal thickness.

13. The radial shaft sealing ring according to claim 12, wherein a ratio d/T of said lip seal thickness (d) to said depth (T) of said thread is in the range of 1.5 to 2.2.

14. The radial shaft sealing ring according to claim 3, wherein a contact width of said sealing bulge is inversely proportional to a thread depth so that a smaller contact width corresponds to a larger thread depth and, a smaller thread depth corresponds to a larger contact width.

15. The radial shaft sealing ring according to claim 1, wherein said sealing surface includes a covering on the shaft, said covering amounting to 3% to 10% of a shaft diameter.

16. The radial shaft sealing ring according to claim 1, wherein a displacement of said sealing lip amounts to 0.05 to 0.3 mm.

17. The radial shaft sealing ring according to claim 1, wherein the sealing element includes a dust lip.
